(19) United States
(12) Patent Application Publication
(10) Pub. No.: US 2026/0066602 A1
(43) Pub. Date: Mar. 5, 2026

(54) LASER CHAMBER, DISCHARGE-EXCITATION-TYPE GAS LASER DEVICE, AND ELECTRONIC DEVICE MANUFACTURING METHOD

(71) Applicant: Gigaphoton Inc., Oyama-shi (JP)

(72) Inventor: Hitoshi OHGA, Oyama-shi (JP)

(73) Assignee: Gigaphoton Inc., Oyama-shi (JP)

(21) Appl. No.: 19/259,834

(22) Filed: Jul. 3, 2025

(30) Foreign Application Priority Data
Aug. 28, 2024 (JP) 2024-146752

(51) Int. Cl. H01S 3/036; H01S 3/04; H01S 3/041

(52) U.S. Cl. CPC H01S 3/036; H01S 3/0407; H01S 3/041

(57) ABSTRACT

A laser chamber includes a guide portion arranged therein such that at least a part of a first guide surface extends between first and second virtual curves over a first section of first and second virtual logarithmic spirals. The first virtual curve has a curvature decreasing along a flow direction and is a virtual curve from a first phase angle to a second phase angle of the first virtual logarithmic spiral in which an angle at which a straight line from an origin and a tangent of the first virtual curve intersect is 103°. The second virtual curve has a curvature decreasing along the flow direction and is a virtual curve from the first phase angle to the second phase angle of the second virtual logarithmic spiral in which an angle at which a straight line from the origin and a tangent of the second virtual curve intersect is 96°.

### CROSS-REFERENCE TO RELATED APPLICATIONS

The present application claims the benefit of Japanese Patent Application No. 2024-146752, filed on Aug. 28, 2024, the entire contents of which are hereby incorporated by reference.

### BACKGROUND

### 1. Technical Field

The present disclosure relates to a laser chamber, a discharge-excitation-type gas laser device, and an electronic device manufacturing method.

### 2. Related Art

Recently, in a semiconductor exposure apparatus, improvement in resolution has been desired for miniaturization and high integration of semiconductor integrated circuits. For this purpose, an exposure light source that outputs light having a shorter wavelength has been developed. For example, as a gas laser device for exposure, a KrF excimer laser device for outputting laser light having a wavelength of about 248 nm and an ArF excimer laser device for outputting laser light having a wavelength of about 193 nm are used.

The KrF excimer laser device and the ArF excimer laser device each have a large spectral line width of about 350 to 400 pm in natural oscillation light. Therefore, when a projection lens is formed of a material that transmits ultraviolet rays such as KrF laser light and ArF laser light, there is a case in which chromatic aberration occurs. As a result, the resolution may decrease. Then, a spectral line width of laser light output from the gas laser device needs to be line-narrowed to the extent that the chromatic aberration can be ignored. For this purpose, there is a case in which a line narrowing module (LNM) including a line narrowing element (etalon, grating, and the like) is provided in a laser resonator of the gas laser device to line-narrow a spectral line width. A gas laser device with a narrowed spectral line width is referred to as a line narrowing gas laser device.

### LIST OF DOCUMENTS

### Patent Documents

Patent Document 1: Japanese Patent Application Publication No. 2022-112652

### SUMMARY

A laser chamber of a discharge-excitation-type gas laser device according to an aspect of the present disclosure includes first and second discharge electrodes arranged to face each other in a direction parallel to a first direction, each of the first and second discharge electrodes extending in a second direction perpendicular to the first direction; a fan arranged in the laser chamber, and configured to cause a laser gas in the laser chamber to circulate therethrough; a cooling unit arranged in the laser chamber, and configured to cool the laser gas; and a guide portion configured to rotate, around an axis parallel to the second direction, a flow direction of the laser gas having passed between the first and second discharge electrodes in a third direction perpendicular to both the first direction and the second direction, and direct the laser gas toward the cooling unit. Here, the guide portion is arranged in the laser chamber such that, when the laser chamber is viewed in cross-section in a plane perpendicular to the second direction, at least a part of a first guide surface extending from a guide surface front end which is an end portion of the guide portion in the first direction on an upstream side in the flow direction to a guide surface rear end which is an end portion in a direction opposite to the first direction on a downstream side in the flow direction extends between first and second virtual curves over a first section corresponding to a phase angle magnitude of 90° or more of first and second virtual logarithmic spirals. The first virtual curve has a curvature decreasing along the flow direction and is a virtual curve from a first phase angle to a second phase angle of the first virtual logarithmic spiral in which an angle at which a straight line from an origin and a tangent of the first virtual curve intersect each other is 103°. The second virtual curve has a curvature decreasing along the flow direction and is a virtual curve from the first phase angle to the second phase angle of the second virtual logarithmic spiral in which an angle at which a straight line from the origin and a tangent of the second virtual curve intersect each other is 96°.

A discharge-excitation-type gas laser device according to an aspect of the present disclosure includes an optical resonator, and a laser chamber arranged on an optical path of the optical resonator. Here, the laser chamber includes first and second discharge electrodes arranged to face each other in a direction parallel to a first direction, each of the first and second discharge electrodes extending in a second direction perpendicular to the first direction; a fan arranged in the laser chamber, and configured to cause a laser gas in the laser chamber to circulate therethrough; a cooling unit arranged in the laser chamber, and configured to cool the laser gas; and a guide portion configured to rotate, around an axis parallel to the second direction, a flow direction of the laser gas having passed between the first and second discharge electrodes in a third direction perpendicular to both the first direction and the second direction, and direct the laser gas toward the cooling unit. The guide portion is arranged in the laser chamber such that, when the laser chamber is viewed in cross-section in a plane perpendicular to the second direction, at least a part of a first guide surface extending from a guide surface front end which is an end portion of the guide portion in the first direction on an upstream side in the flow direction to a guide surface rear end which is an end portion in a direction opposite to the first direction on a downstream side in the flow direction extends between first and second virtual curves over a first section corresponding to a phase angle magnitude of 90° or more of first and second virtual logarithmic spirals. The first virtual curve has a curvature decreasing along the flow direction and is a virtual curve from a first phase angle to a second phase angle of the first virtual logarithmic spiral in which an angle at which a straight line from an origin and a tangent of the first virtual curve intersect each other is 103°. The second virtual curve has a curvature decreasing along the flow direction and is a virtual curve from the first phase angle to the second phase angle of the second virtual logarithmic spiral in which an angle at which a straight line from the origin and a tangent of the second virtual curve intersect each other is 96°.

An electronic device manufacturing method according to an aspect of the present disclosure includes generating laser light using a discharge-excitation-type gas laser device, outputting the laser light to an exposure apparatus, and exposing a photosensitive substrate to the laser light in the exposure apparatus to manufacture an electronic device. Here, the gas laser device includes an optical resonator, and a laser chamber arranged on an optical path of the optical resonator. The laser chamber includes first and second discharge electrodes arranged to face each other in a direction parallel to a first direction, each of the first and second discharge electrodes extending in a second direction perpendicular to the first direction; a fan arranged in the laser chamber, and configured to cause a laser gas in the laser chamber to circulate therethrough; a cooling unit arranged in the laser chamber, and configured to cool the laser gas; and a guide portion configured to rotate, around an axis parallel to the second direction, a flow direction of the laser gas having passed between the first and second discharge electrodes in a third direction perpendicular to both the first direction and the second direction, and direct the laser gas toward the cooling unit. The guide portion is arranged in the laser chamber such that, when the laser chamber is viewed in cross-section in a plane perpendicular to the second direction, at least a part of a first guide surface extending from a guide surface front end which is an end portion of the guide portion in the first direction on an upstream side in the flow direction to a guide surface rear end which is an end portion in a direction opposite to the first direction on a downstream side in the flow direction extends between first and second virtual curves over a first section corresponding to a phase angle magnitude of 90° or more of first and second virtual logarithmic spirals. The first virtual curve has a curvature decreasing along the flow direction and is a virtual curve from a first phase angle to a second phase angle of the first virtual logarithmic spiral in which an angle at which a straight line from an origin and a tangent of the first virtual curve intersect each other is 103°. The second virtual curve has a curvature decreasing along the flow direction and is a virtual curve from the first phase angle to the second phase angle of the second virtual logarithmic spiral in which an angle at which a straight line from the origin and a tangent of the second virtual curve intersect each other is 96°.

### BRIEF DESCRIPTION OF THE DRAWINGS

Embodiments of the present disclosure will be described below merely as examples with reference to the accompanying drawings.

FIG. 1 shows the configuration of a laser device of a comparative example.

FIG. 2 shows the configuration of a part of the laser device according to the comparative example viewed in a −Z direction.

FIG. 3 shows the flow of a laser gas in the comparative example.

FIG. 4 shows the configuration of the laser device of a first embodiment.

FIG. 5 shows the configuration of a part of the laser device according to the first embodiment viewed in the −Z direction.

FIG. 6 shows first and second virtual curves.

FIG. 7 shows a first example of the shape of a first guide surface extending between the first and second virtual curves.

FIG. 8 shows a second example of the shape of the first guide surface extending between the first and second virtual curves.

FIG. 9 shows a third example of the shape of the first guide surface extending between the first and second virtual curves.

FIG. 10 shows a fourth example of the shape of the first guide surface extending between the first and second virtual curves.

FIG. 11 shows a drawing method of a fifth example of the shape of the first guide surface extending between the first and second virtual curves.

FIG. 12 shows the fifth example of the shape of the first guide surface obtained from FIG. 11.

FIG. 13 shows a first example of a first section over which the first guide surface extends.

FIG. 14 shows a second example of the first section over which the first guide surface extends.

FIG. 15 shows a third example of the first section over which the first guide surface extends.

FIG. 16 shows a fourth example of the first section over which the first guide surface extends.

FIG. 17 shows the configuration of a part of the laser device according to a second embodiment viewed in the −Z direction.

FIG. 18 shows the configuration of an exposure system.

### DESCRIPTION OF EMBODIMENTS

### Contents

1. Comparative example
   1.1 Configuration
   1.2 Operation
2. Problem of comparative example
3. Guide portion 28 having curvature decreasing along flow direction of laser gas
   3.1 First guide surface 281 having logarithmic spiral shape
   3.2 First guide surface 281 including combination of plurality of arcs
   3.3 First guide surface 281 including part of ellipse
   3.4 First guide surface 281 including combination of plurality of arcs and external common tangents
   3.5 Section over which first guide surface 281 extends
   3.6 Effect
4. Shape and position of guide portion 28
   4.1 Inclination of second guide surface 282
   4.2 Relationship with inclined member 12c
   4.3 Effect
5. Others
   5.1 Electronic device manufacturing method
   5.2 Laser control processor 30
   5.3 Supplement

Hereinafter, embodiments of the present disclosure will be described in detail with reference to the drawings. The embodiments described below shows some examples of the present disclosure and do not limit the contents of the present disclosure. Also, all configurations and operation described in the embodiments are not necessarily essential as configurations and operation of the present disclosure. Here, the same components are denoted by the same reference numeral, and duplicate description thereof is omitted.

### 1. Comparative Example

### 1.1 Configuration

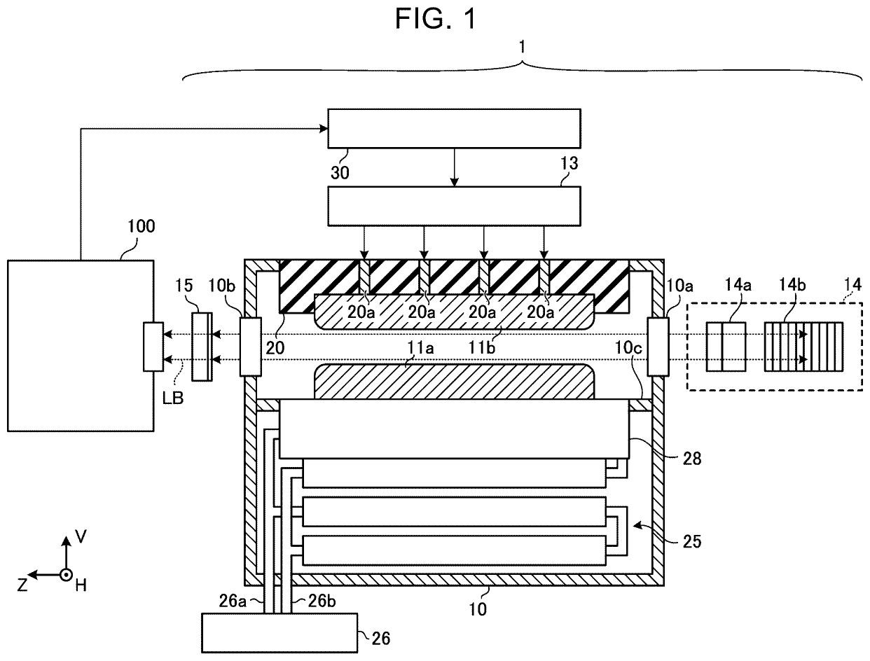

FIG. 1 shows the configuration of a laser device 1 of a comparative example. The comparative example of the present disclosure is an example recognized by the applicant as known only by the applicant, and is not a publicly known example admitted by the applicant.

The laser device 1 is a discharge-excitation-type gas laser device capable of outputting laser light LB to an exposure apparatus 100. The laser device 1 includes a laser chamber 10 including first and second discharge electrodes 11a, 11b, a power source device 13, a line narrowing module 14, an output coupling mirror 15, and a laser control processor 30. The line narrowing module 14 and the output coupling mirror 15 configure an optical resonator. The laser chamber 10 includes windows 10a, 10b, and is arranged such that the windows 10a, 10b are located on the optical path of the optical resonator. The laser control processor 30 will be described later.

The travel direction of the laser light LB output from the output coupling mirror 15 is represented by a Z direction. Each of the first and second discharge electrodes 11a, 11b extends in the Z direction. The direction in which the first and second discharge electrodes 11a, 11b face each other is defined as a V direction or a −V direction. The Z direction and the V direction are perpendicular to each other, and the direction perpendicular to both of them is represented by a H direction or a −H direction. The V direction, the Z direction, and the H direction correspond to the first, second, and third directions in the present disclosure, respectively. In FIG. 1, the configuration of the laser device 1 is shown as viewed in the −H direction.

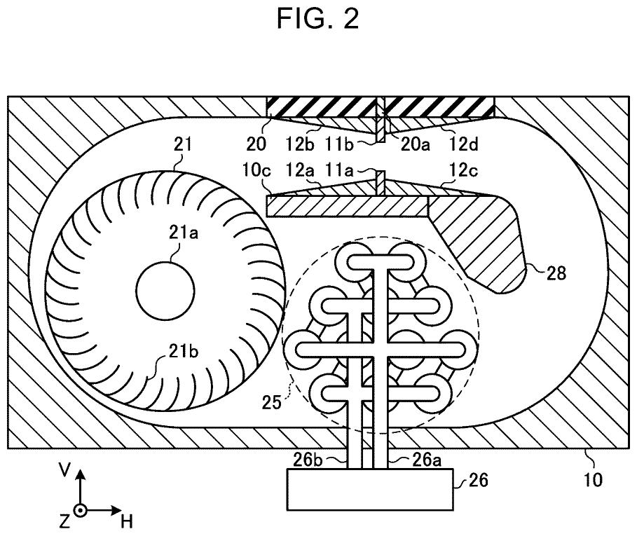

FIG. 2 shows the configuration of a part of the laser device 1 according to the comparative example viewed in a −Z direction. The laser chamber 10 accommodates the first and second discharge electrodes 11a, 11b, inclined members 12a to 12d, a cross flow fan 21, a cooling unit 25, and a guide portion 28.

The laser chamber 10 is filled with a laser gas containing, for example, an argon gas or a krypton gas as a rare gas, a fluorine gas as a halogen gas, a neon gas as a buffer gas, and the like. Alternatively, a laser gas containing a fluorine gas and a buffer gas may be enclosed.

An opening is formed in a part of the laser chamber 10, which is closed by an electrically insulating portion 20. The electrically insulating portion 20 supports the second discharge electrode 11b. A plurality of conductive portions 20a are embedded in the electrically insulating portion 20. Each of the conductive portions 20a is electrically connected to the second discharge electrode 11b. The power source device 13 includes a charger (not shown) and is connected to the second discharge electrode 11b via the conductive portions 20a. Each of the inclined members 12b, 12d has a triangular prism shape, and is fixed to the electrically insulating portion 20 so as to cover a part of two side surfaces of the second discharge electrode 11b.

A return plate 10c is arranged in the laser chamber 10. The first discharge electrode 11a is supported by the return plate 10c. The first discharge electrode 11a is electrically connected to the ground potential via the return plate 10c and a conductive member of the laser chamber 10. As shown in FIG. 2, the return plate 10c defines a gap through which the laser gas passes on each of the front and back sides of the paper surface of FIG. 1. Each of the inclined members 12a and 12c has a triangular prism shape and is fixed to the return plate 10c so as to cover a part of two side surfaces of the first discharge electrode 11a. The inclined members 12a, 12c may include porous members for reducing acoustic waves generated at a discharge space between the first and second discharge electrodes 11a, 11b.

The inclined members 12a, 12b are arranged to gradually narrow the flow path of the laser gas so as to efficiently guide the laser gas fed from the cross flow fan 21 to the discharge space between the first and second discharge electrodes 11a, 11b. The inclined members 12c, 12d are arranged to gradually expand the flow path of the laser gas so as to efficiently guide the laser gas having passed through the discharge space in a direction of approaching the guide portion 28.

The cross flow fan 21 includes a plurality of blades 21b arranged around a rotation shaft 21a. The rotation shaft 21a is connected to a motor (not shown). The cross flow fan 21 corresponds to the fan in the present disclosure.

The cooling unit 25 includes a plurality of refrigerant pipes and heat radiation fins arranged around each of the refrigerant pipes. Each of the refrigerant pipes is arranged such that the longitudinal direction thereof extends in the Z direction. The refrigerant pipes are connected to a heat exchanger 26 via pipes 26a, 26b.

The guide portion 28 is fixed to the inclined member 12c so as to guide the laser gas having passed between the inclined members 12c, 12d to the cooling unit 25.

The line narrowing module 14 includes a prism 14a and a grating 14b. The prism 14a is arranged on the optical path of light output from the window 10a. The grating 14b is arranged on the optical path of the light having transmitted through the prism 14a. The output coupling mirror 15 is configured by a partial reflection mirror.

### 1.2 Operation

The laser control processor 30 receives a target value of a pulse energy E and a light emission trigger signal from the exposure apparatus 100. The laser control processor 30 transmits setting data of a charge voltage to the charger included in the power source device 13 based on the target value of the pulse energy E. Further, the laser control processor 30 transmits a trigger signal to the power source device 13 based on the light emission trigger signal.

Upon receiving the trigger signal from the laser control processor 30, the power source device 13 generates a pulse high voltage from the electric energy charged to the charger and applies the high voltage between the first and second discharge electrodes 11a, 11b.

When the high voltage is applied between the first and second discharge electrodes 11a, 11b, discharge occurs between the first and second discharge electrodes 11a, 11b. The laser medium in the laser chamber 10 is excited by the energy of the discharge and shifts to a high energy level. When the excited laser medium then shifts to a low energy level, light having a wavelength corresponding to the difference between the energy levels is emitted.

The light generated in the laser chamber 10 is output to the outside of the laser chamber 10 through the windows 10a, 10b. The beam width in the H direction of the light output through the window 10a of the laser chamber 10 is expanded by the prism 14a, and then the light is incident on the grating 14b.

The light incident on the grating 14b is reflected by a plurality of grooves of the grating 14b and is diffracted in a direction corresponding to the wavelength of the light. By matching the incident angle of the light incident on the grating 14b with the diffraction angle of the diffracted light having a desired wavelength, the wavelength of the diffracted light incident on the prism 14a from the grating 14b is selected. The prism 14a reduces the beam width in the H direction of the diffracted light incident thereon from the grating 14b and returns the light to the laser chamber 10 through the window 10a.

The output coupling mirror 15 transmits and outputs a part of the light output from the window 10b of the laser chamber 10, and reflects the other part back into the laser chamber 10.

In this way, the light output from the laser chamber 10 reciprocates between the line narrowing module 14 and the output coupling mirror 15, and is amplified each time the light passes through the discharge space between the first and second discharge electrodes 11a, 11b. The light is line narrowed each time being turned back in the line narrowing module 14. Thus, the light having undergone laser oscillation and line narrowing is output as the laser light LB from the output coupling mirror 15.

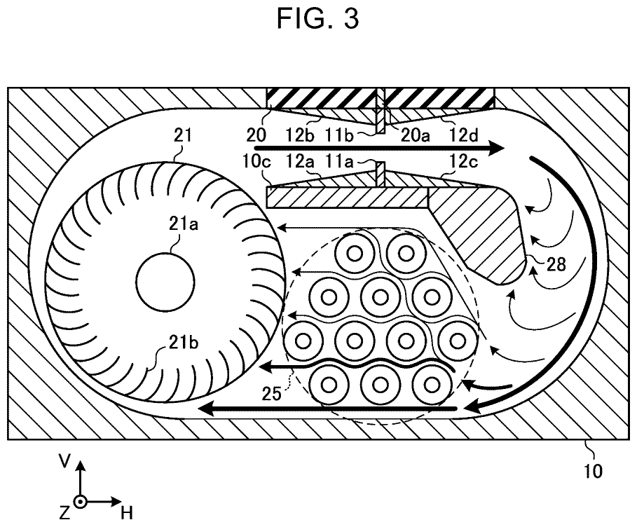

FIG. 3 shows the flow of the laser gas in the comparative example. The components shown in FIG. 3 are the same as those in FIG. 2, but the pipes 26a, 26b and the heat exchanger 26 are not shown.

When the motor (not shown) rotates the cross flow fan 21, the laser gas flows and circulates through the inside of the laser chamber 10 as indicated by arrows in FIG. 3. Discharge products generated by the discharge between the first and second discharge electrodes 11a, 11b are removed from the discharge space by the flow of the laser gas by the time of the subsequent discharge, and the discharge space and the vicinity thereof are in a state in which there is little discharge products, so that the discharge can be stabilized.

The cooling unit 25 cools the laser gas by absorbing the thermal energy of the laser gas that has reached a high temperature due to the discharge. The thermal energy is discharged to the outside of the laser chamber 10 through a refrigerant.

### 2. Problem of Comparative Example

In FIG. 3, the relative magnitude of the flow velocity of the laser gas is represented by the thickness of the arrows. The laser gas having passed between the first and second discharge electrodes 11a, 11b and between the inclined members 12c, 12d in the H direction passes between the inner surface of the laser chamber 10 and the guide portion 28, and thus the flow direction of the laser gas is rotated about an axis parallel to the Z direction, and is guided to the cooling unit 25. As a result of simulating the flow of the laser gas, it was found that stagnation staying around the guide portion 28 occurs in addition to a main flow flowing in a laminar flow along the inner surface of the laser chamber 10. It is presumed that stagnation occurs because the inclination of the surface of the guide portion 28 suddenly changes with respect to the inclination of the surface of the inclined member 12c, so that the laser gas flowing along the surface of the inclined member 12c separates from the surface of the guide portion 28 and becomes turbulent.

Such stagnation gives flow path resistance to the main flow of the laser gas, and may cause the path of the main flow to be unevenly distributed on the inner surface side of the laser chamber 10. As a result, the flow path cross section of the main flow of the laser gas, which is a laminar flow, may be reduced.

The main flow of the laser gas flows into the cooling unit 25 along the inner surface of the laser chamber 10. In the cooling unit 25, branched flows are generated by the flow of the laser gas between the plurality of refrigerant pipes. Since the gas has a property of flowing according to its inertia, the flow rate of the branched flow at a position far from the inner surface of the laser chamber 10 may be less than that of the branched flow at a position close to the inner surface of the laser chamber 10. In this case, the refrigerant pipes far from the inner surface of the laser chamber 10 cannot sufficiently contribute to cooling of the laser gas, and conversely, the refrigerant pipes close to the inner surface of the laser chamber 10 may not sufficiently cool the laser gas. Therefore, in order to obtain a sufficient cooling effect, it is necessary to increase the number of revolutions of the cross flow fan 21 to increase the flow rate of the laser gas passing through the cooling unit 25, which increases energy consumption. Further, when the number of revolutions of the cross flow fan 21 is increased, there is a possibility that turbulence is more likely to occur due to the laser gas being separated from the surface of the guide portion 28.

Embodiments described below relate to providing a discharge-excitation-type gas laser device that suppresses separation of the laser gas from the surface of the guide portion 28 to improve the flow of the laser gas and improve energy efficiency.

### 3. Guide Portion 28 Having Curvature Decreasing Along Flow Direction of Laser Gas

### 3.1 First Guide Surface 281 Having Logarithmic Spiral Shape

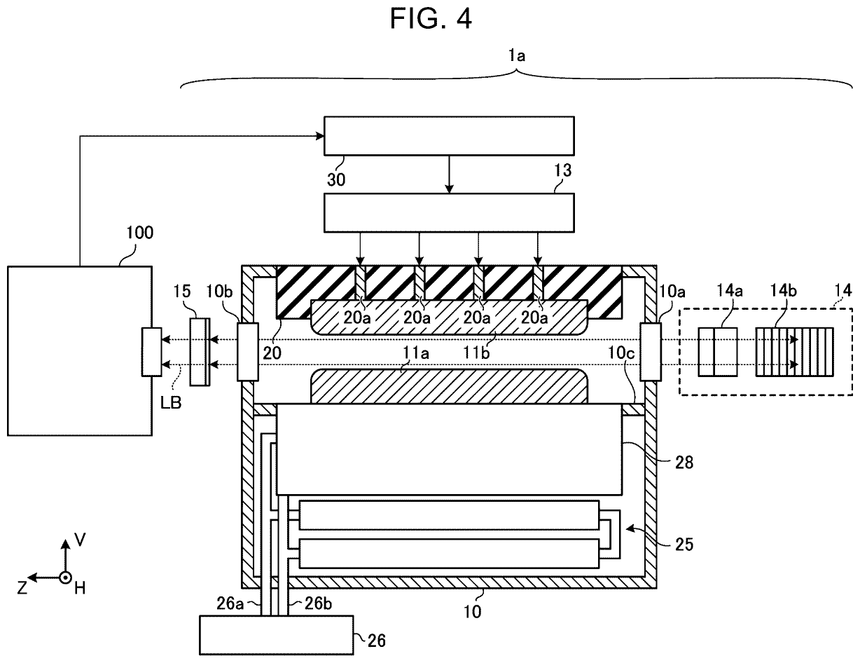

FIG. 4 shows the configuration of a laser device 1a of a first embodiment. The laser device 1a differs from that of the comparative example in the shape of the guide portion 28.

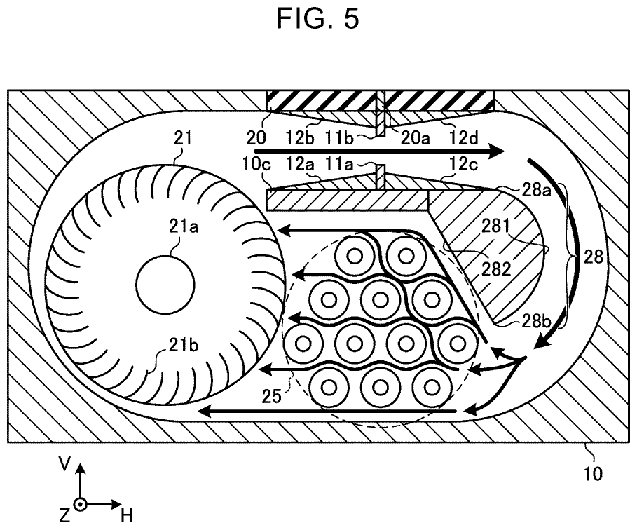

FIG. 5 shows the configuration of a part of the laser device 1a according to the first embodiment viewed in the −Z direction. The pipes 26a, 26b and the heat exchanger 26 are not shown. The guide portion 28 includes a guide surface front end 28a that is an end portion in the V direction on the upstream side in the flow direction of the laser gas, and a guide surface rear end 28b that is an end portion in the −V direction on the downstream side. The guide portion 28 includes a first guide surface 281 extending from the guide surface front end 28a to the guide surface rear end 28b, and a second guide surface 282 extending downstream from the guide surface rear end 28b in the flow direction. The first guide surface 281 extends between first and second virtual curves L1, L2 described below when viewed in cross-section in a plane perpendicular to the Z direction.

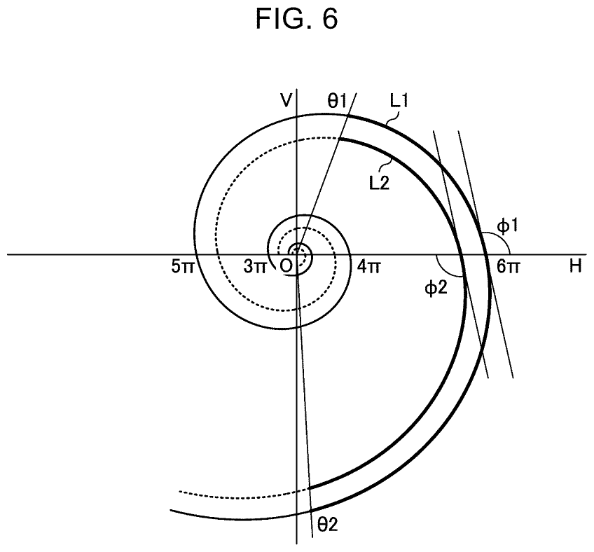

FIG. 6 shows the first and second virtual curves L1, L2. Each of the first and second virtual curves L1, L2 is a curve in which the curvature decreases along the flow direction. The first virtual curve L1 is a part from a first phase angle θ1 to a second phase angle θ2 of a first virtual logarithmic spiral in which an angle φ1 at which a straight line from the origin O and a tangent of the first virtual curve L1 intersect each other is 103°. The second virtual curve L2 is a part from the first phase angle θ1 to the second phase angle θ2 of a second virtual logarithmic spiral in which an angle φ2 at which a straight line from the origin O and a tangent of the second virtual curve L2 intersect each other is 96°. In the first and second virtual curves L1, L2, the angles φ1, φ2 differ from each other, but the origin O and the first and second phase angles θ1, θ2 are the same. The angle difference θ2-θ1 between the first and second phase angles θ1, θ2 is preferably 90° or more and 180° or less.

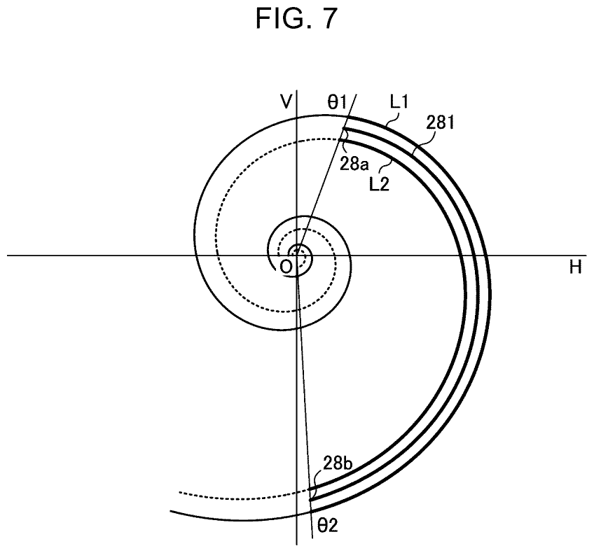

FIG. 7 shows a first example of the shape of the first guide surface 281 extending between the first and second virtual curves L1, L2. The first guide surface 281 may have a logarithmic spiral shape, and the angle at which a straight line from the origin of the logarithmic spiral and a tangent of the logarithmic spiral intersect each other may be, for example, 99°. Here, the origin of the logarithmic spiral configuring the first guide surface 281 may not be common to the origin O of the first and second virtual logarithmic spirals. Further, the first guide surface 281 may not have a perfect logarithmic spiral shape. By forming the first guide surface 281 to extend between the first and second virtual curves L1, L2, the curvature thereof may decrease along the flow direction.

Due to this shape, as shown in FIG. 5, the flow of laser gas is attracted to the first guide surface 281 by the Coanda effect. By decreasing the curvature of the first guide surface 281 along the flow direction, the Coanda effect is maintained over the entire length of the first guide surface 281, and separation of the laser gas from the first guide surface 281 and the occurrence of stagnation associated therewith are suppressed. Therefore, uneven distribution of the main flow of the laser gas is suppressed, the flow rate difference of the branched flow in the cooling unit 25 is reduced, and the cooling efficiency can be improved.

### 3.2 First Guide Surface 281 Including Combination of Plurality of Arcs

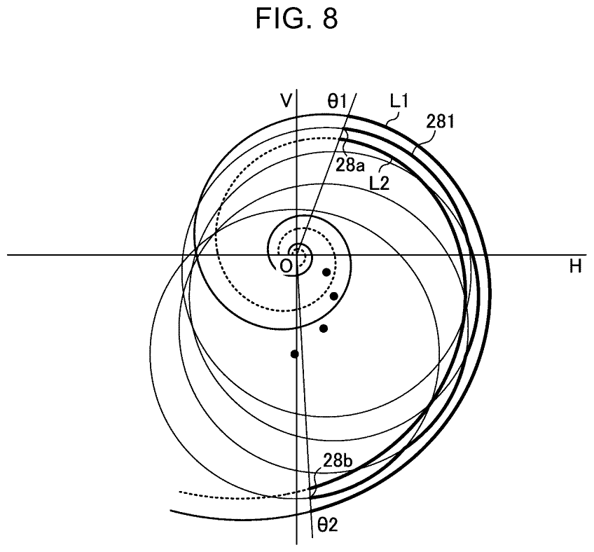

FIG. 8 shows a second example of the shape of the first guide surface 281 extending between the first and second virtual curves L1, L2. The first guide surface 281 may include a combination of a plurality of arcs having different centers. The center of each arc is indicated by a black circle. The radii of the arcs may be equal to each other. The number of the arcs may be three or more.

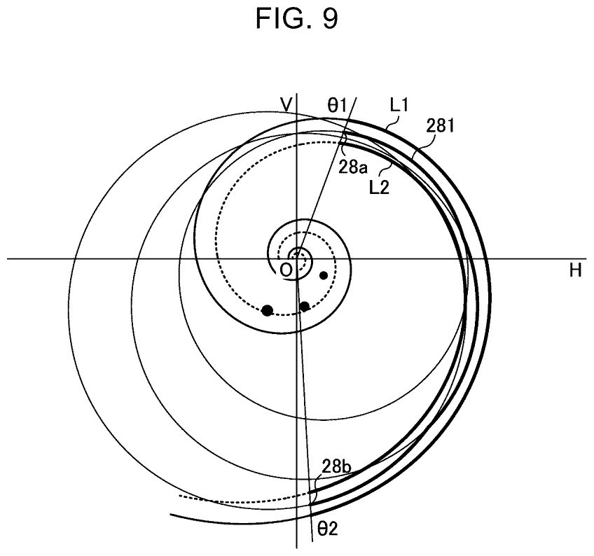

FIG. 9 shows a third example of the shape of the first guide surface 281 extending between the first and second virtual curves L1, L2. The first guide surface 281 may include a combination of a plurality of arcs having different centers and radii increasing along the flow direction.

### 3.3 First Guide Surface 281 Including Part of Ellipse

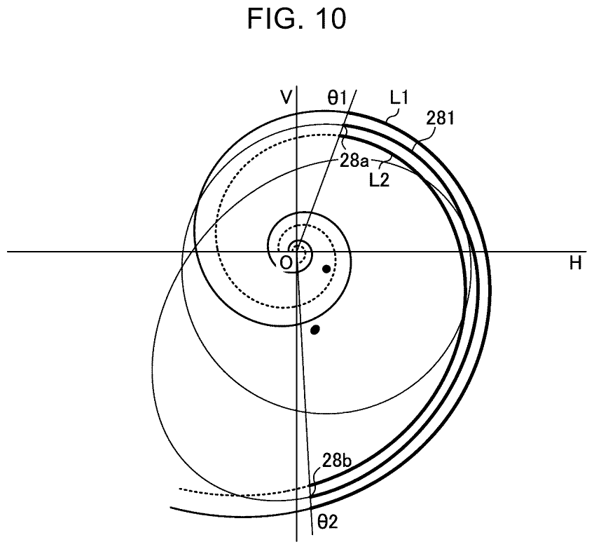

FIG. 10 shows a fourth example of the shape of the first guide surface 281 extending between the first and second virtual curves L1, L2. The first guide surface 281 may include parts of ellipses that vary in curvature along the flow direction. An arc may be included in addition to an ellipse. There may be a plurality of ellipses or arcs. Instead of an ellipse, a quadratic curve other than an ellipse may be used.

### 3.4 First Guide Surface 281 Including Combination of Plurality of Arcs and External Common Tangents

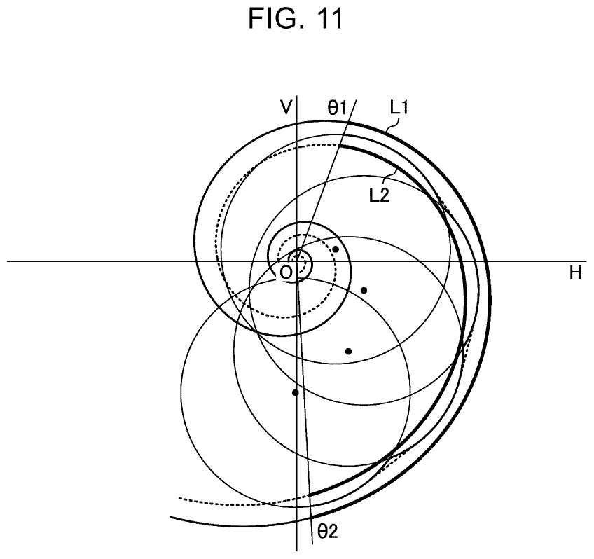

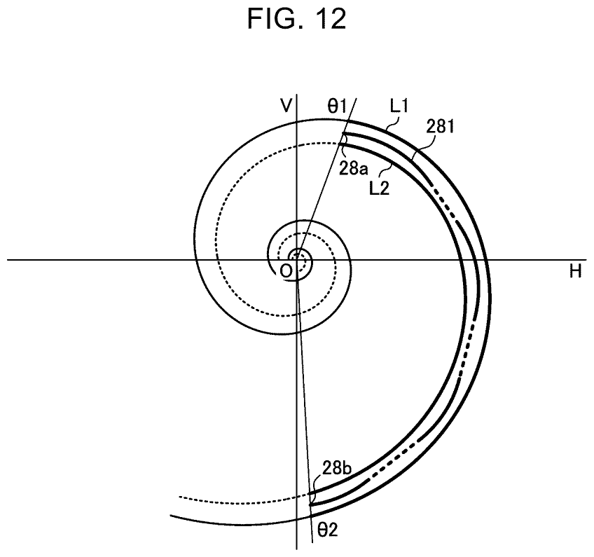

FIG. 11 shows a drawing method of a fifth example of the shape of the first guide surface 281 extending between the first and second virtual curves L1, L2, and FIG. 12 shows the fifth example of the shape of the first guide surface 281 obtained from FIG. 11. The first guide surface 281 may include a combination of a plurality of arcs having different centers and external common tangents thereof. Three or more arcs may be included, and in this case, the external common tangents may only be each external common tangents of arcs whose centers are adjacent to each other.

### 3.5 Section Over Which First Guide Surface 281 Extends

FIGS. 7 to 12 describe a case in which the first guide surface 281 extends over the entire first and second virtual curves L1, L2 from the first phase angle θ1 to the second phase angle θ2. The section from the first phase angle θ1 to the second phase angle θ2 corresponds to the second section in the present disclosure. In FIGS. 7 to 12, the guide surface front end 28a is located at a position corresponding to the first phase angle θ1, and the guide surface rear end 28b is located at a position corresponding to the second phase angle θ2. The present disclosure is not limited thereto, and the first guide surface 281 may extend over a first section corresponding to a phase angle magnitude of 90° or more of the virtual logarithmic spiral of the first and second virtual curves L1, L2. The first section is a section within the second section.

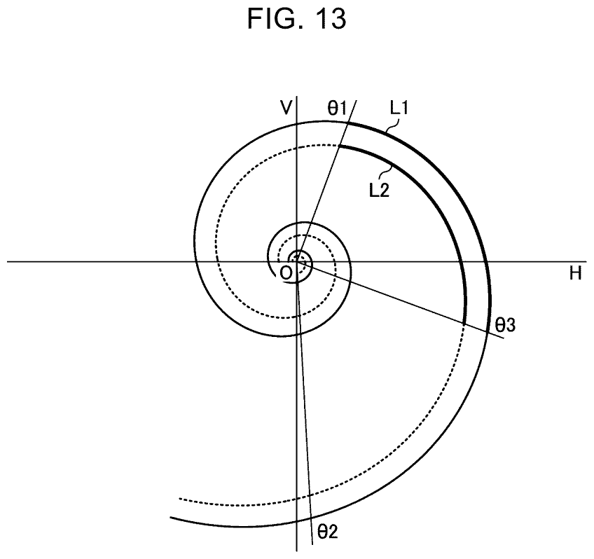

FIG. 13 shows a first example of the first section over which the first guide surface 281 extends. The first guide surface 281 may extend over the first section from the first phase angle θ1 to a third phase angle θ3 which is an angle between the first and second phase angles θ1, θ2. The guide surface front end 28a may be located at a position corresponding to the first phase angle θ1.

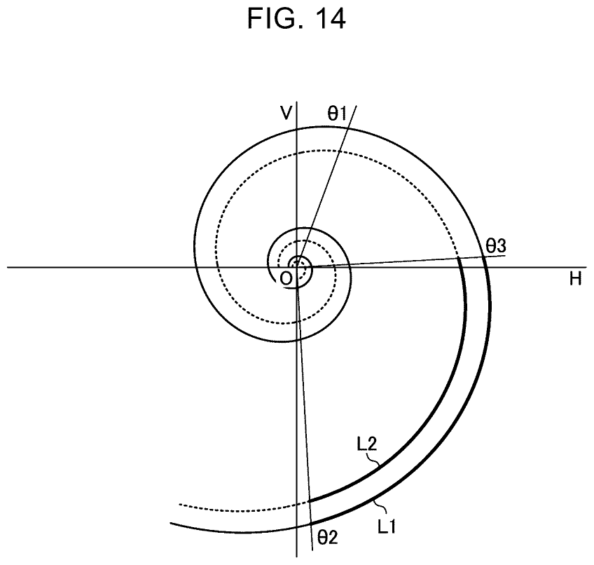

FIG. 14 shows a second example of the first section over which the first guide surface 281 extends. The first guide surface 281 may extend over the first section from the third phase angle θ3, which is an angle between the first and second phase angles θ1, θ2, to the second phase angle θ2. The guide surface rear end 28b may be located at a position corresponding to the second phase angle Θ2.

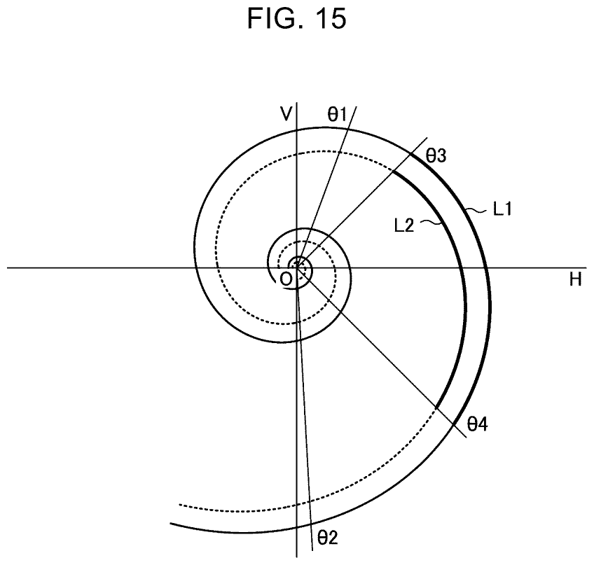

FIG. 15 shows a third example of the first section over which the first guide surface 281 extends. The first guide surface 281 may extend over the first section from the third phase angle θ3, which is an angle between the first and second phase angles θ1, θ2, to a fourth phase angle θ4 which is an angle between the third and second phase angles θ3, θ2.

Although a case in which the first section is a continuous section has been described in FIGS. 7 to 15, the present disclosure is not limited thereto. The first section may include a plurality of discontinuous sections within the second section, and the sum of the phase angle magnitude is simply required to be 90° or more.

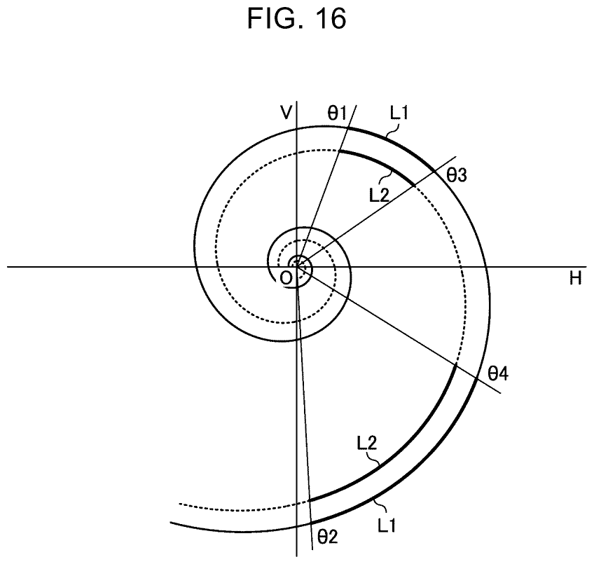

FIG. 16 shows a fourth example of the first section over which the first guide surface 281 extends. The first guide surface 281 may extend over the first section including a section from a first phase angle θ1 to a third phase angle θ3, which is an angle between the first and second phase angles θ1, θ2, and a section from a fourth phase angle θ4, which is an angle between the third and second phase angles θ3, θ2, to the second phase angle θ2. The guide surface front end 28a may be located at a position corresponding to the first phase angle θ1, and the guide surface rear end 28b may be located at a position corresponding to the second phase angle θ2. The first section may include three or more discontinuous sections.

### 3.6 Effect

(1) According to the first embodiment, the laser chamber 10 of the discharge-excitation-type gas laser device includes the first and second discharge electrodes 11a, 11b, the cross flow fan 21, the cooling unit 25, and the guide portion 28. The first and second discharge electrodes 11a, 11b are first and second discharge electrodes 11a, 11b arranged to face each other in a direction parallel to the V direction, and each of the first and second discharge electrodes 11a, 11b extends in the Z direction perpendicular to the V direction. The cross flow fan 21 is arranged in the laser chamber 10, and causes the laser gas in the laser chamber 10 to circulate therethrough. The cooling unit 25 is arranged in the laser chamber 10 and cools the laser gas. The guide portion 28 rotates, around an axis parallel to the Z direction, the flow direction of the laser gas having passed between the first and second discharge electrodes 11a, 11b in the H direction perpendicular to both the V direction and the Z direction, and directs the laser gas toward the cooling unit 25. The guide portion 28 is arranged in the laser chamber 10 such that, when the laser chamber 10 is viewed in cross-section in a plane perpendicular to the Z direction, at least a part of the first guide surface 281 extending from the guide surface front end 28a, which is the end portion of the guide portion 28 in the V direction on the upstream side in the flow direction, to the guide surface rear end 28b, which is the end portion in the direction opposite to the V direction on the downstream side, extends between the first and second virtual curves L1, L2 over the first section corresponding to a phase angle magnitude of 90° or more of the first and second virtual logarithmic spirals. The first virtual curve L1 has a curvature decreasing along the flow direction, and is a virtual curve from the first phase angle θ1 to the second phase angle θ2 of the first virtual logarithmic spiral in which an angle φ1 at which a straight line from the origin O and a tangent of the first virtual curve L1 intersect each other is 103°. The second virtual curve L2 has a curvature decreasing along the flow direction, and is a virtual curve from the first phase angle θ1 to the second phase angle θ2 of the second virtual logarithmic spiral in which an angle φ2 at which a straight line from the origin O and a tangent of the second virtual curve L2 intersect each other is 96°.

According to this configuration, by extending the first guide surface 281 between the first and second virtual curves L1, L2 in which the curvature decreases along the flow direction, it is possible to suppress the flow of the laser gas from being separated from the first guide surface 281. Further, it is possible to suppress generation of stagnation of the laser gas in the vicinity of the first guide surface 281. Accordingly, since uneven distribution of the flow of the laser gas flowing into the cooling unit 25 can be suppressed, the cooling effect at the cooling unit 25 can be improved, and the energy efficiency can be improved.
(2) According to the second and third examples of the shape of the first guide surface 281 in the first embodiment, the first guide surface 281 includes a combination of a plurality of arcs having different centers when viewed in cross-section in a plane perpendicular to the Z direction.

According to this configuration, by configuring the first guide surface 281 by combining a plurality of arcs, it is possible to obtain the effect of improving the flow of the laser gas with a shape that is easy to be manufactured.
(3) According to the third example of the shape of the first guide surface 281 in the first embodiment, the first guide surface 281 includes a combination of a plurality of arcs having different centers and radii increasing along the flow direction when viewed in cross-section in a plane perpendicular to the Z direction.

According to this configuration, by increasing the radii of the arcs along the flow direction, a part of the first guide surface 281 can have a shape close to a logarithmic spiral in which the curvature decreases along the flow direction. Further, it is possible to reduce the number of combined arcs to make it easier to manufacture.
(4) According to the fourth example of the shape of the first guide surface 281 in the first embodiment, the first guide surface 281 includes a part of an ellipse in which the curvature changes along the flow direction when viewed in cross-section in a plane perpendicular to the Z direction.

According to this configuration, since the ellipse has a large curvature in the vicinity of the end portion of the major axis and the curvature decreases toward the vicinity of the end portion of the minor axis, it is possible to have a shape close to a logarithmic spiral in which the curvature decreases along the flow direction in a part of the first guide surface 281 by using a part of the ellipse.
(5) According to the fifth example of the shape of the first guide surface 281 in the first embodiment, the first guide surface 281 includes a combination of a plurality of arcs having different centers and external common tangents thereof when viewed in cross-section in a plane perpendicular to the Z direction.

According to this configuration, by combining a plurality of arcs and external common tangents, a concave portion in the vicinity of an intersection of the plurality of arcs can be made linear, and it is possible to further improve the flow of the laser gas.
(6) According to the fifth example of the shape of the first guide surface 281 in the first embodiment, the first guide surface 281 includes a combination of three or more arcs having different centers and external common tangents of the arcs, centers of which are adjacent to each other when viewed in cross-section in a plane perpendicular to the Z direction.

According to this configuration, by combining three or more arcs, an effect of improvement can be obtained over a wide range in the flow direction.
(7) According to some examples in the first embodiment, the first guide surface 281 extends over the second section including the first section, the second section corresponding to a section from the first phase angle θ1 to the second phase angle θ2 of the first and second virtual logarithmic spirals.

According to this configuration, it is possible to suppress the flow of the laser gas from being separated from the first guide surface 281 over a wide range in the flow direction, and to suppress the occurrence of stagnation of the laser gas in the vicinity of the first guide surface 281.
(8) According to some examples in the first embodiment, the guide surface front end 28a is located at a position corresponding to the first phase angle θ1, and the guide surface rear end 28b is located at a position corresponding to the second phase angle θ2.

According to this configuration, it is possible to suppress the flow of the laser gas from being separated from the first guide surface 281 over the entire first guide surface 281, and to suppress the occurrence of stagnation of the laser gas.
(9) According to the first example of the first section in the first embodiment, the first section is a section from the first phase angle θ1 to the third phase angle θ3, which is an angle between the first and second phase angles θ1, θ2, and the guide surface front end 28a is located at a position corresponding to the first phase angle θ1.

According to this configuration, since the flow of the laser gas is improved in the first section from the first phase angle θ1 where the guide surface front end 28a is located to the third phase angle θ3, the cooling effect at the cooling unit 25 can be improved.
(10) According to the second example of the first section in the first embodiment, the first section is a section from the third phase angle θ3, which is an angle between the first and second phase angles θ1, θ2 to the second phase angle θ2, and the guide surface rear end 28b is located at a position corresponding to the second phase angle θ2.

According to this configuration, since the flow of the laser gas is improved in the first section from the third phase angle θ3 to the second phase angle θ2 where the guide surface rear end 28b is located, the cooling effect at the cooling unit 25 can be improved.
(11) According to the first to third examples of the first section in the first embodiment, the first section is a continuous section.

According to this configuration, since the flow of the laser gas is improved in a continuous section of 90°or more, the cooling effect at the cooling unit 25 can be improved.
(12) According to the fourth example of the first section in the first embodiment, the first section includes a plurality of discontinuous sections in which the sum of the phase angle magnitude of the is 90° or more.

According to this configuration, by making the sum of the plurality of discontinuous sections to be 90° or more, the flow of the laser gas can be improved, and the cooling effect at the cooling unit 25 can be improved.
(13) According to the fourth example of the first section in the first embodiment, the guide surface front end 28a is located at a position corresponding to the first phase angle θ1, and the guide surface rear end 28b is located at a position corresponding to the second phase angle θ2.

According to this configuration, the flow of the laser gas is improved both in the vicinity of the guide surface front end 28a and in the vicinity of the guide surface rear end 28b, so that the cooling effect at the cooling unit 25 can be improved.

In other respects, the first embodiment is similar to the comparative example.

### 4. Shape and Position of Guide Portion 28

### 4.1 Inclination of Second Guide Surface 282

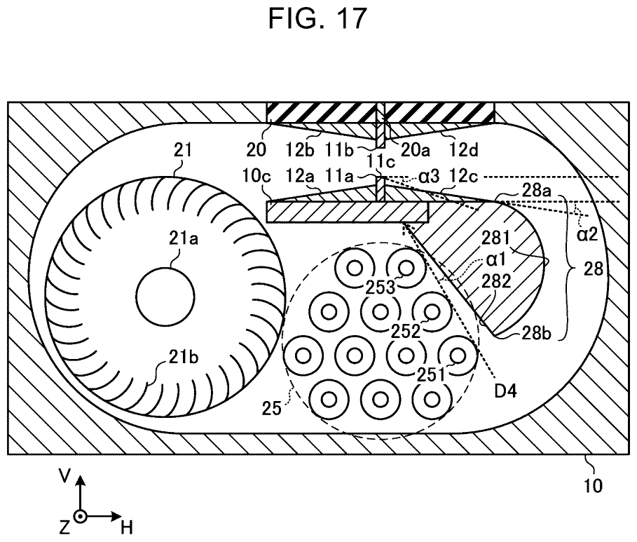

FIG. 17 shows the configuration of a part of the laser device 1a according to a second embodiment viewed in the-Z direction. The pipes 26a, 26b and the heat exchanger 26 are not shown. The arrangement direction of first to third cooling pipes 251 to 253 of the cooling unit 25 arranged along the second guide surface 282 is referred to as a fourth direction D4. The second guide surface 282 is substantially parallel to the fourth direction D4 in the first embodiment, but the present disclosure is not limited thereto. An angle α1 between the second guide surface 282 and the fourth direction D4 may be 5° or less.

When the second guide surface 282 is not parallel to the fourth direction D4, it is desirable that the first to third cooling pipes 251 to 253 are arranged so as to be closer to the second guide surface 282 as the distance from the guide surface rear end 28b increases.

4.2 Relationship with Inclined Member 12c

As shown in FIG. 17, it is desirable that the guide surface front end 28a coincides with a ridge line which is an end portion of the inclined member 12c in the H direction. Further, when viewed in cross-section in a plane perpendicular to the Z direction, it is desirable that the tangent of the first guide surface 281 in the vicinity of the guide surface front end 28a and the surface of the inclined member 12c coincide with each other. It is desirable that an angle α2 between a tangent of the first guide surface 281 in the vicinity of the guide surface front end 28a and the H direction is 4° or less.

The inclined member 12c and the guide portion 28 are arranged such that a straight line inclined by an angle α3 with respect to the H direction from the center of the discharge surface 11c of the first discharge electrode 11a facing the second discharge electrode 11b passes through the inclined member 12c. The angle α3 is 6°.

### 4.3 Effect

(14) According to the second embodiment, the guide portion 28 includes the second guide surface 282 extending from the guide surface rear end 28b to the downstream side in the flow direction. Further, the cooling unit 25 includes the first and second cooling pipes 251, 252 arranged in the fourth direction D4 perpendicular to the Z direction and facing the second guide surface 282, and the angle α1 between the fourth direction D4 and the second guide surface 282 is 5° or less.

According to this configuration, by making the second guide surface 282 substantially parallel to the fourth direction D4 in which the first and second cooling pipes 251, 252 are arranged, the laser gas easily flows in the direction along the second guide surface 282 as well, and the cooling efficiency of the entire cooling unit 25 can be improved.
(15) According to the second embodiment, the distance between the guide surface rear end 28b and the first cooling pipe 251 is shorter than the distance between the guide surface rear end 28b and the second cooling pipe 252, and the distance between the second guide surface 282 and the first cooling pipe 251 is longer than the distance between the second guide surface 282 and the second cooling pipe 252.

According to this configuration, when the second guide surface 282 is inclined with respect to the fourth direction D4 within a range of 5° or less, the gas can efficiently flow around the first and second cooling pipes 251, 252, and the cooling efficiency can be improved by making the distance from the second guide surface 282 thereto smaller as the distance from the guide surface rear end 28b increases.
(16) According to the second embodiment, the laser chamber 10 includes the inclined member 12c that guides the laser gas having passed between the first and second discharge electrodes 11a, 11b in a direction of approaching the guide portion 28. Further, when viewed in cross-section in a plane perpendicular to the Z direction, the surface of the inclined member 12c and the tangent of the first guide surface 281 in the vicinity of the guide surface front end 28a coincide with each other.

According to this configuration, the flow of the laser gas is smoothly taken over from the inclined member 12c to the guide portion 28, and the flow of the laser gas can be improved.
(17) According to the second embodiment, the angle α2 between the tangent and the H direction is 4° or less.

According to this configuration, by suppressing the inclination of the tangent of the first guide surface 281, the flow of the laser gas along the first guide surface 281 can be improved.
(18) According to the second embodiment, a straight line inclined by 6° with respect to the H direction from the center of the discharge surface 11c of the first discharge electrode 11a facing the second discharge electrode 11b close to the inclined member 12c out of the first and second discharge electrodes 11a, 11b passes through the inclined member 12c.

According to this configuration, by sufficiently securing the distance in the H direction from the discharge surface 11c of the first discharge electrode 11a to the guide surface front end 28a, the flow of the laser gas along the first guide surface 281 can be improved.

In other respects, the second embodiment is similar to the first embodiment.

### 5. Others

5.1 Electronic Device Manufacturing Method

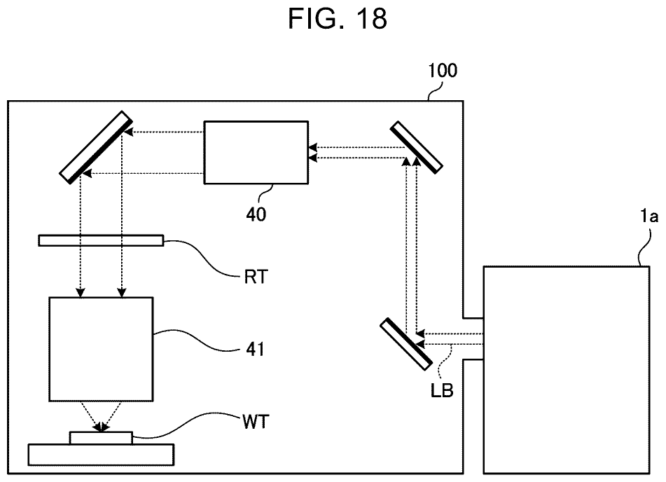

FIG. 18 shows the configuration of an exposure system. The exposure system includes the laser device 1a and the exposure apparatus 100. The laser device 1a is configured to output the laser light LB toward the exposure apparatus 100.

The exposure apparatus 100 includes an illumination optical system 40 and a projection optical system 41. The illumination optical system 40 illuminates a reticle pattern of a reticle (not shown) arranged on a reticle stage RT with the laser light LB incident from the laser device 1a. The projection optical system 41 causes the laser light LB transmitted through the reticle to be imaged as being reduced and projected on a workpiece (not shown) arranged on a workpiece table WT. The workpiece is a photosensitive substrate such as a semiconductor wafer on which photoresist is applied.

The exposure apparatus 100 synchronously translates the reticle stage RT and the workpiece table WT to expose the workpiece to the laser light LB reflecting the reticle pattern. After the reticle pattern is transferred onto the semiconductor wafer by the exposure process described above, an electronic device can be manufactured through a plurality of processes.

### 5.2 Laser Control Processor 30

The laser control processor 30 may be physically configured as hardware to execute various processes included in the present disclosure. For example, the laser control processor 30 may be a computer including a memory that stores a control program defining the various processes and a processing device that executes the control program. The control program may be stored in one memory, or may be stored separately in a plurality of memories at physically separate locations, and the various processes included may be defined by the control program as an aggregation thereof. The processing device may be a general-purpose processing device such as a CPU or a special-purpose processing device such as a GPU.

Alternatively, the laser control processor 30 may be programmed as software to execute the various processes included in the present disclosure. For example, the laser control processor 30 may be implemented in a dedicated device such as an ASIC or a programmable device such as an FPGA.

The various processes included in the present disclosure may be executed by one computer, one dedicated device, or one programmable device, or may be executed by cooperation of a plurality of computers, a plurality of dedicated devices, or a plurality of programmable devices at physically separate locations. The various processes may be executed by a combination including at least any two of: one or more computers, one or more dedicated devices, and one or more programmable devices.

### 5.3 Supplement

The description above is intended to be illustrative and the present disclosure is not limited thereto. Therefore, it would be obvious to those skilled in the art that various modifications to the embodiments of the present disclosure would be possible without departing from the spirit and the scope of the appended claims. Further, it would be also obvious to those skilled in the art that the embodiments of the present disclosure would be appropriately combined.

The terms used throughout the present specification and the appended claims should be interpreted as non-limiting terms unless clearly described. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more.” Further, “at least one of A, B, and C” should be interpreted to mean any of A, B, C, A+B, A+C, B+C, and A+B+C as well as to include combinations of any thereof and any other than A, B, and C.

What is claimed is:

1. A laser chamber of a discharge-excitation-type gas laser device, comprising:
first and second discharge electrodes arranged to face each other in a direction parallel to a first direction, each of the first and second discharge electrodes extending in a second direction perpendicular to the first direction;
a fan arranged in the laser chamber, and configured to cause a laser gas in the laser chamber to circulate therethrough;
a cooling unit arranged in the laser chamber, and configured to cool the laser gas; and
a guide portion configured to rotate, around an axis parallel to the second direction, a flow direction of the laser gas having passed between the first and second discharge electrodes in a third direction perpendicular to both the first direction and the second direction, and direct the laser gas toward the cooling unit,
the guide portion being arranged in the laser chamber such that, when the laser chamber is viewed in cross-section in a plane perpendicular to the second direction, at least a part of a first guide surface extending from a guide surface front end which is an end portion of the guide portion in the first direction on an upstream side in the flow direction to a guide surface rear end which is an end portion in a direction opposite to the first direction on a downstream side in the flow direction extends between first and second virtual curves over a first section corresponding to a phase angle magnitude of 90° or more of first and second virtual logarithmic spirals,
the first virtual curve having a curvature decreasing along the flow direction and being a virtual curve from a first phase angle to a second phase angle of the first virtual logarithmic spiral in which an angle at which a straight line from an origin and a tangent of the first virtual curve intersect each other is 103°, and
the second virtual curve having a curvature decreasing along the flow direction and being a virtual curve from the first phase angle to the second phase angle of the second virtual logarithmic spiral in which an angle at which a straight line from the origin and a tangent of the second virtual curve intersect each other is 96°.

2. The laser chamber according to claim 1,
wherein the first guide surface includes a combination of a plurality of arcs having different centers when viewed in cross-section in a plane perpendicular to the second direction.

3. The laser chamber according to claim 1,
wherein the first guide surface includes a combination of a plurality of arcs having different centers and radii increasing along the flow direction when viewed in cross-section in a plane perpendicular to the second direction.

4. The laser chamber according to claim 1,
wherein the first guide surface includes a part of an ellipse in which a curvature changes along the flow direction when viewed in cross-section in a plane perpendicular to the second direction.

5. The laser chamber according to claim 1,
wherein the first guide surface includes a combination of a plurality of arcs having different centers and external common tangents of the arcs when viewed in cross-section in a plane perpendicular to the second direction.

6. The laser chamber according to claim 1,
wherein the first guide surface includes a combination of three or more arcs having different centers and external common tangents of the arcs, centers of which are adjacent to each other when viewed in cross-section in a plane perpendicular to the second direction.

7. The laser chamber according to claim 1,
wherein the first guide surface extends over a second section including the first section, the second section corresponding to a section from the first phase angle to the second phase angle of the first and second virtual logarithmic spirals.

8. The laser chamber according to claim 7,
wherein the guide surface front end is located at a position corresponding to the first phase angle, and the guide surface rear end is located at a position corresponding to the second phase angle.

9. The laser chamber according to claim 1,
wherein the first section is a section from the first phase angle to a third phase angle which is an angle between the first and second phase angles, and the guide surface front end is located at a position corresponding to the first phase angle.

10. The laser chamber according to claim 1,
wherein the first section is a section from a third phase angle which is an angle between the first and second phase angles to the second phase angle, and the guide surface rear end is located at a position corresponding to the second phase angle.

11. The laser chamber according to claim 1,
wherein the first section is a continuous section.

12. The laser chamber according to claim 1,
wherein the first section includes a plurality of discontinuous sections in which a sum of phase angle magnitudes is 90° or more.

13. The laser chamber according to claim 12,
wherein the laser guide surface front end is located at a position corresponding to the first phase angle, and the guide surface rear end is located at a position corresponding to the second phase angle.

14. The laser chamber according to claim 1,
wherein the guide portion includes a second guide surface extending from the guide surface rear end to a downstream side in the flow direction, and
the cooling unit includes first and second cooling pipes arranged in a fourth direction perpendicular to the second direction and facing the second guide surface, and an angle between the fourth direction and the second guide surface is 5° or less.

15. The laser chamber according to claim 14,
wherein a distance between the guide surface rear end and the first cooling pipe is shorter than a distance between the guide surface rear end and the second cooling pipe, and
a distance between the second guide surface and the first cooling pipe is longer than a distance between the second guide surface and the second cooling pipe.

16. The laser chamber according to claim 1,
further comprising an inclined member that guides the laser gas having passed between the first and second discharge electrodes in a direction of approaching the guide portion,
wherein a surface of the inclined member and a tangent of the first guide surface in the vicinity of the guide surface front end coincides with each other when viewed in a plane perpendicular to the second direction.

17. The laser chamber according to claim 16,
wherein an angle between the tangent and the third direction is 4° or less.

18. The laser chamber according to claim 16,
wherein a straight line inclined by 6° with respect to the third direction from a center of a discharge surface of the first discharge electrode facing the second discharge electrode close to the inclined member out of the first and second discharge electrodes passes through the inclined member.

19. A discharge-excitation-type gas laser device comprising:
an optical resonator; and
a laser chamber arranged on an optical path of the optical resonator,
the laser chamber including:
first and second discharge electrodes arranged to face each other in a direction parallel to a first direction, each of the first and second discharge electrodes extending in a second direction perpendicular to the first direction;
a fan arranged in the laser chamber, and configured to cause a laser gas in the laser chamber to circulate therethrough;
a cooling unit arranged in the laser chamber, and configured to cool the laser gas; and
a guide portion configured to rotate, around an axis parallel to the second direction, a flow direction of the laser gas having passed between the first and second discharge electrodes in a third direction perpendicular to both the first direction and the second direction, and direct the laser gas toward the cooling unit,
the guide portion being arranged in the laser chamber such that, when the laser chamber is viewed in cross-section in a plane perpendicular to the second direction, at least a part of a first guide surface extending from a guide surface front end which is an end portion of the guide portion in the first direction on an upstream side in the flow direction to a guide surface rear end which is an end portion in a direction opposite to the first direction on a downstream side in the flow direction extends between first and second virtual curves over a first section corresponding to a phase angle magnitude of 90° or more of first and second virtual logarithmic spirals,
the first virtual curve having a curvature decreasing along the flow direction and being a virtual curve from a first phase angle to a second phase angle of the first virtual logarithmic spiral in which an angle at which a straight line from an origin and a tangent of the first virtual curve intersect each other is 103°, and
the second virtual curve having a curvature decreasing along the flow direction and being a virtual curve from the first phase angle to the second phase angle of the second virtual logarithmic spiral in which an angle at which a straight line from the origin and a tangent of the second virtual curve intersect each other is 96°.

20. An electronic device manufacturing method, comprising:
generating laser light using a discharge-excitation-type gas laser device;
outputting the laser light to an exposure apparatus; and
exposing a photosensitive substrate to the laser light in the exposure apparatus to manufacture an electronic device,
the gas laser device including an optical resonator, and a laser chamber arranged on an optical path of the optical resonator,
the laser chamber including:
first and second discharge electrodes arranged to face each other in a direction parallel to a first direction, each of the first and second discharge electrodes extending in a second direction perpendicular to the first direction;
a fan arranged in the laser chamber, and configured to cause a laser gas in the laser chamber to circulate therethrough;
a cooling unit arranged in the laser chamber, and configured to cool the laser gas; and
a guide portion configured to rotate, around an axis parallel to the second direction, a flow direction of the laser gas having passed between the first and second discharge electrodes in a third direction perpendicular to both the first direction and the second direction, and direct the laser gas toward the cooling unit,
the guide portion being arranged in the laser chamber such that, when the laser chamber is viewed in cross-section in a plane perpendicular to the second direction, at least a part of a first guide surface extending from a guide surface front end which is an end portion of the guide portion in the first direction on an upstream side in the flow direction to a guide surface rear end which is an end portion in a direction opposite to the first direction on a downstream side in the flow direction extends between first and second virtual curves over a first section corresponding to a phase angle magnitude of 90° or more of first and second virtual logarithmic spirals,
the first virtual curve having a curvature decreasing along the flow direction and being a virtual curve from a first phase angle to a second phase angle of the first virtual logarithmic spiral in which an angle at which a straight line from an origin and a tangent of the first virtual curve intersect each other is 103°, and
the second virtual curve having a curvature decreasing along the flow direction and being a virtual curve from the first phase angle to the second phase angle of the second virtual logarithmic spiral in which an angle at which a straight line from the origin and a tangent of the second virtual curve intersect each other is 96°.
